(19) United States
(12) Patent Application Publication
(10) Pub. No.: US 2016/0160882 A1
(43) Pub. Date: Jun. 9, 2016

(54) PORT GEOMETRY FOR PRESSURE EXCHANGER

(71) Applicant: Energy Recovery, Inc., San Leandro, CA (US)

(72) Inventor: Patrick William Morphew, San Leandro, CA (US)

(21) Appl. No.: 14/957,345

(22) Filed: Dec. 2, 2015

Related U.S. Application Data
(60) Provisional application No. 62/088,205, filed on Dec. 5, 2014.

(51) Int. Cl. F15B 3/00

(52) U.S. Cl. CPC F15B 3/00

(57) ABSTRACT

A system includes a rotary isobaric pressure exchanger (IPX) for transferring energy from a high pressure fluid to a low pressure fluid, including a rotor that rotates circumferentially about a rotational axis and having a first end face and a second end face disposed opposite each other with a plurality of channels extending axially between respective apertures located in the first and second end faces. The system includes a first and second end cover with first and second surfaces that slidingly and sealingly engage the first and second end faces. The first and second end covers have at least one fluid inlet and outlet that rotate about the rotational axis and fluidly communicate with at least one channel of the plurality of channels. The fluid inlets have a plurality of apertures, where each aperture has a first leading edge that corresponds to a contour of at least one channel.

### CROSS-REFERENCE TO RELATED APPLICATION

This application claims priority to and benefit of U.S. Provisional Patent Application No. 62/088,205, entitled “Port Geometry for Pressure Exchanger” filed on Dec. 5, 2014, which is herein incorporated by reference in its entirety.

### BACKGROUND

This section is intended to introduce the reader to various aspects of art that may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Fluid handling equipment, such as rotary pumps and pressure exchangers, may be susceptible to loss in efficiency, loss in performance, wear, and sometimes breakage over time. As a result, the equipment must be taken off line for inspection, repair, and/or replacement. Unfortunately, the downtime of this equipment may be labor intensive and costly for the particular plant, facility, or work site. In certain instances, the fluid handling equipment may be susceptible to misalignment, imbalances, or other irregularities, which may increase wear and other problems, and also cause unexpected downtime. This equipment downtime is particularly problematic for continuous operations. Therefore, a need exists to increase the reliability and longevity of fluid handling equipment.

### BRIEF DESCRIPTION OF THE DRAWINGS

Various features, aspects, and advantages of the present invention will become better understood when the following detailed description is read with reference to the accompanying figures in which like characters represent like parts throughout the figures, wherein:

FIG. 1 is an exploded perspective view of an embodiment of a rotary isobaric pressure exchanger (rotary IPX);

FIG. 2 is an exploded perspective view of an embodiment of a rotary IPX in a first operating position;

FIG. 3 is an exploded perspective view of an embodiment of a rotary IPX in a second operating position;

FIG. 4 is an exploded perspective view of an embodiment of a rotary IPX in a third operating position;

FIG. 5 is an exploded perspective view of an embodiment of a rotary IPX in a fourth operating position;

FIG. 6 is a schematic cross-sectional view of an embodiment of the rotary IPX of FIG. 1;

FIG. 7 is a schematic diagram of an embodiment of a fluid interface of the rotary IPX of FIG. 1;

FIG. 8 is a schematic diagram of an embodiment of a fluid interface of the rotary IPX of FIG. 1, in which a channel forms a point contact with an aperture;

FIG. 9 is a schematic diagram of an embodiment of a fluid interface of the rotary IPX of FIG. 1, in which a channel partially overlaps an aperture;

FIG. 10 is a schematic diagram of an embodiment of a fluid interface of the rotary IPX of FIG. 1, in which a channel fluidly overlaps an aperture;

FIG. 11 is a schematic diagram of an embodiment of an aperture of the rotary IPX of FIG. 1 having a curved geometry;

FIG. 12 is a schematic diagram of an embodiment of a fluid interface of the rotary IPX of FIG. 1;

FIG. 13 is a schematic diagram of an embodiment of a fluid interface of the rotary IPX of FIG. 1, in which a channel forms a line contact with an aperture;

FIG. 14 is a schematic diagram of an embodiment of a fluid interface of the rotary IPX of FIG. 1, in which a channel partially overlaps an aperture;

FIG. 15 is an axial view of an interior surface of the end cover having spotfaces on the apertures; and

FIG. 16 is a schematic diagram of an embodiment of a frac system with a hydraulic energy transfer system.

### DETAILED DESCRIPTION OF SPECIFIC EMBODIMENTS

One or more specific embodiments of the present invention will be described below. These described embodiments are only exemplary of the present invention. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As discussed in detail below, a hydraulic energy transfer system transfers work and/or pressure between a first fluid (e.g., a pressure exchange fluid) and a second fluid (e.g., frac fluid or a salinated fluid). In certain embodiments, the first fluid may be substantially “cleaner” than the second fluid. In other words, the second fluid may contain dissolved and/or suspended particles. Moreover, in certain embodiments, the second fluid may be more viscous than the first fluid. Additionally, the first fluid may be at a first pressure between approximately 5,000 kPa to 25,000 kPa, 20,000 kPa to 50,000 kPa, 40,000 kPa to 75,000 kPa, 75,000 kPa to 100,000 kPa or greater than a second pressure of the second fluid. In operation, the hydraulic energy transfer system may or may not completely equalize pressures between the first and second fluids. Accordingly, the hydraulic energy transfer system may operate isobarically, or substantially isobarically (e.g., wherein the pressures of the first and second fluids equalize within approximately +/−1, 2, 3, 4, 5, 6, 7, 8, 9, or 10 percent of each other).

The hydraulic energy transfer system may also be described as a hydraulic protection system, hydraulic buffer system, or a hydraulic isolation system, because it blocks or limits contact between the second fluid and various pieces of hydraulic equipment (e.g., high-pressure pumps, heat exchangers), while still exchanging work and/or pressure between the first and second fluids. By blocking or limiting contact between various pieces of hydraulic equipment and the second fluid (e.g., more viscous fluid, fluid with suspended solids), the hydraulic energy transfer system reduces abrasion/wear, thus increasing the life/performance of this equipment (e.g., high-pressure pumps). Moreover, it may enable the hydraulic system to use less expensive equipment, for example high-pressure pumps that are not designed for abrasive fluids (e.g., fluids with suspended particles). In some embodiments, the hydraulic energy transfer system may be a hydraulic turbocharger, a rotating isobaric pressure exchanger (e.g., rotary IPX), or a non-rotating isobaric pressure exchanger (e.g., bladder, reciprocating isobaric pressure exchanger). Rotating and non-rotating isobaric pressure exchangers may be generally defined as devices that transfer fluid pressure between a high-pressure inlet stream and a low-pressure inlet stream at efficiencies in excess of approximately 50%, 60%, 70%, 80%, or 90% without utilizing centrifugal technology.

As explained above, the hydraulic energy transfer system transfers work and/or pressure between first and second fluids. These fluids may be multi-phase fluids such as gas/liquid flows, gas/solid particulate flows, liquid/solid particulate flows, gas/liquid/solid particulate flows, or any other multi-phase flow. Moreover, these fluids may be non-Newtonian fluids (e.g., shear thinning fluid), highly viscous fluids, non-Newtonian fluids containing proppant, or highly viscous fluids containing proppant. The proppant may include sand, solid particles, powders, debris, ceramics, or any combination therefore. For example, the disclosed embodiments may be used with oil and gas equipment, such as hydraulic fracturing equipment using a proppant (e.g., particle laden fluid) to frac rock formations in a well.

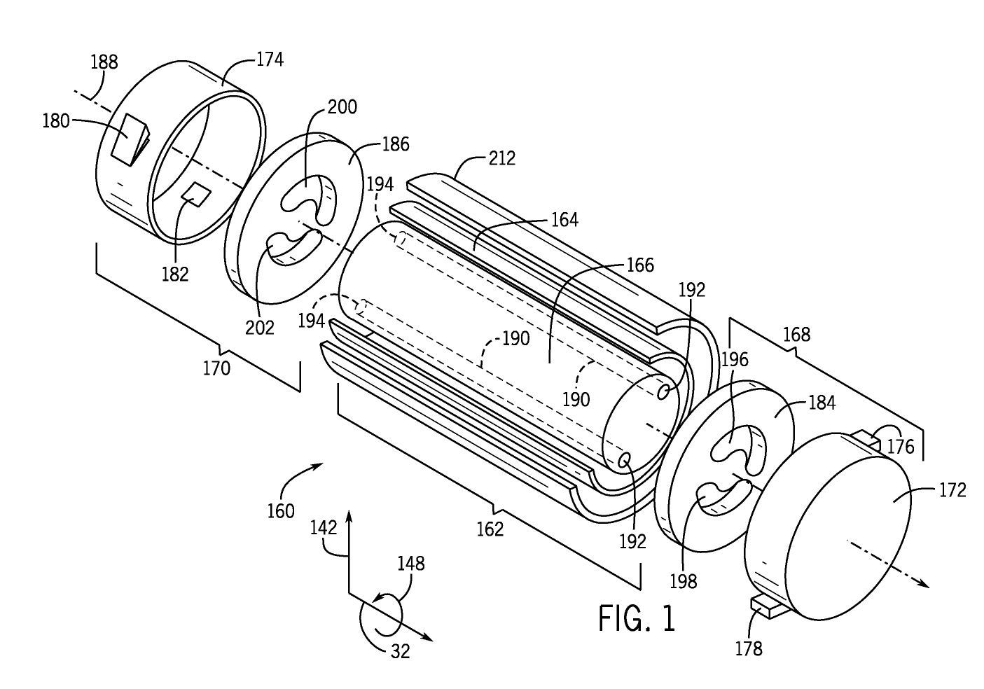

FIG. 1 is an exploded perspective view of an embodiment of a rotary isobaric pressure exchanger 160 (rotary IPX) capable of transferring pressure and/or work between the first and second fluids with minimal mixing of the fluids. The rotary IPX 160 may include a generally cylindrical body portion 162 that includes a sleeve 164 and a rotor 166 disposed within a housing 212. The rotary IPX 160 may also include two end caps 168 and 170 that include manifolds 172 and 174, respectively. Manifold 172 includes respective inlet and outlet ports 176 and 178, while manifold 174 includes respective inlet and outlet ports 180 and 182. In operation, these inlet ports 176, 180 enabling the first fluid to enter the rotary IPX 160 to exchange pressure, while the outlet ports 180, 182 enable the first fluid to then exit the rotary IPX 160. In operation, the inlet port 176 may receive a high-pressure (HP) first fluid, and after exchanging pressure, the outlet port 178 may be used to route a low-pressure (LP) first fluid out of the rotary IPX 160. Similarly, inlet port 180 may receive a LP second fluid and the outlet port 182 may be used to route a HP second fluid out of the rotary IPX 160. The end caps 168 and 170 include respective end covers 184 and 186 disposed within respective manifolds 172 and 174 that enable fluid sealing contact with the rotor 166. The rotor 166 may be cylindrical and disposed in the sleeve 164, which enables the rotor 166 to rotate about the axis 188. The rotor 166 may have a plurality of channels 190 extending substantially longitudinally through the rotor 166 with openings 192 and 194 at each end arranged symmetrically about the longitudinal axis 188. The openings 192 and 194 of the rotor 166 are arranged for hydraulic communication with inlet and outlet apertures 196 and 198; and 200 and 202 in the end covers 184 and 186, in such a manner that during rotation the channels 190 are exposed to fluid at high-pressure and fluid at low-pressure. As illustrated, the inlet and outlet apertures 196 and 198, and 200 and 202 may be designed in the form of arcs or segments of a circle (e.g., C-shaped).

In some embodiments, a controller using sensor feedback may control the extent of mixing between the first and second fluids in the rotary IPX 160, which may be used to improve the operability of the fluid handling system. For example, varying the proportions of the first and second fluids entering the rotary IPX 160 allows the plant operator to control the amount of fluid mixing within the hydraulic energy transfer system. Three characteristics of the rotary IPX 160 that affect mixing are: (1) the aspect ratio of the rotor channels 190, (2) the short duration of exposure between the first and second fluids, and (3) the creation of a fluid barrier (e.g., an interface) between the first and second fluids within the rotor channels 190. First, the rotor channels 190 are generally long and narrow, which stabilizes the flow within the rotary IPX 160. In addition, the first and second fluids may move through the channels 190 in a plug flow regime with very little axial mixing. Second, in certain embodiments, the speed of the rotor 166 reduces contact between the first and second fluids. For example, the speed of the rotor 166 may reduce contact times between the first and second fluids to less than approximately 0.15 seconds, 0.10 seconds, or 0.05 seconds. Third, a small portion of the rotor channel 190 is used for the exchange of pressure between the first and second fluids. Therefore, a volume of fluid remains in the channel 190 as a barrier between the first and second fluids. All these mechanisms may limit mixing within the rotary IPX 160. Moreover, in some embodiments, the rotary IPX 160 may be designed to operate with internal pistons that isolate the first and second fluids while enabling pressure transfer.

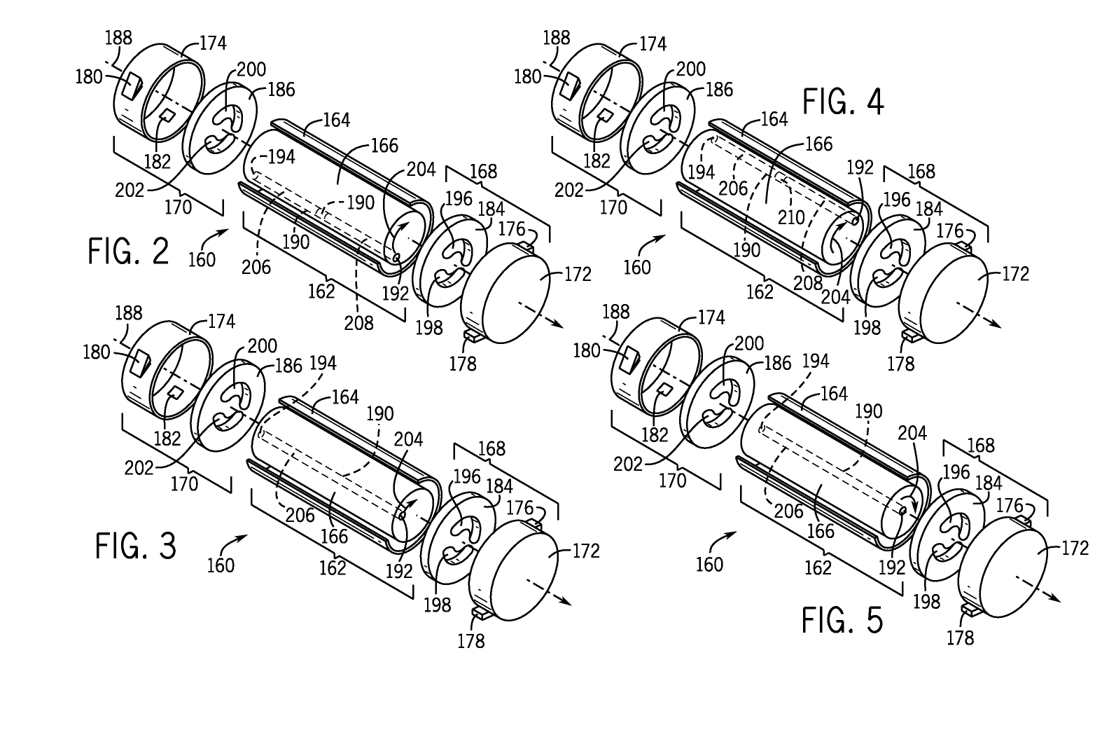

FIGS. 2-5 are exploded views of an embodiment of the rotary IPX 160 illustrating the sequence of positions of a single channel 190 in the rotor 166 as the channel 190 rotates through a complete cycle. It is noted that FIGS. 2-5 are simplifications of the rotary IPX 160 showing one channel 190, and the channel 190 is shown as having a circular cross-sectional shape. In other embodiments, the rotary IPX 160 may include a plurality of channels 190 with the same or different cross-sectional shapes (e.g., circular, oval, square, rectangular, polygonal, etc.). Thus, FIGS. 2-5 are simplifications for purposes of illustration, and other embodiments of the rotary IPX 160 may have configurations different from that shown in FIGS. 2-5. As described in detail below, the rotary IPX 160 facilitates pressure exchange between the first and second fluids by enabling the first and second fluids to momentarily contact each other within the rotor 166. In certain embodiments, this exchange happens at speeds that result in limited mixing of the first and second fluids.

In FIG. 2, the channel opening 192 is in a first position. In the first position, the channel opening 192 is in fluid communication with the aperture 198 in endplate 184 and therefore with the manifold 172, while opposing channel opening 194 is in hydraulic communication with the aperture 202 in end cover 186 and by extension with the manifold 174. As will be discussed below, the rotor 166 may rotate in the clockwise direction indicated by arrow 204. In operation, LP second fluid 206 passes through end cover 186 and enters the channel 190, where it contacts a LP first fluid 208 at a dynamic fluid interface 210. The second fluid 206 then drives the first fluid 208 out of the channel 190, through end cover 184, and out of the rotary IPX 160. However, because of the short duration of contact, there is minimal mixing between the second fluid 206 and the first fluid 208. As will be appreciated, a pressure of the second fluid 206 is greater than a pressure of the first fluid 208, thereby enabling the second fluid 206 to drive the first fluid 208 out of the channel 190.

In FIG. 3, the channel 190 has rotated clockwise through an arc of approximately 90 degrees. In this position, the outlet 194 is no longer in fluid communication with the apertures 200 and 202 of end cover 186, and the opening 192 is no longer in fluid communication with the apertures 196 and 198 of end cover 184. Accordingly, the LP second fluid 206 is temporarily contained within the channel 190.

In FIG. 4, the channel 190 has rotated through approximately 180 degrees of arc from the position shown in FIG. 2. The opening 194 is now in fluid communication with aperture 200 in end cover 186, and the opening 192 of the channel 190 is now in fluid communication with aperture 196 of the end cover 184. In this position, the HP first fluid 208 enters and pressurizes the LP second fluid 206 driving the second fluid 206 out of the fluid channel 190 and through the aperture 200 for use in the system or disposal.

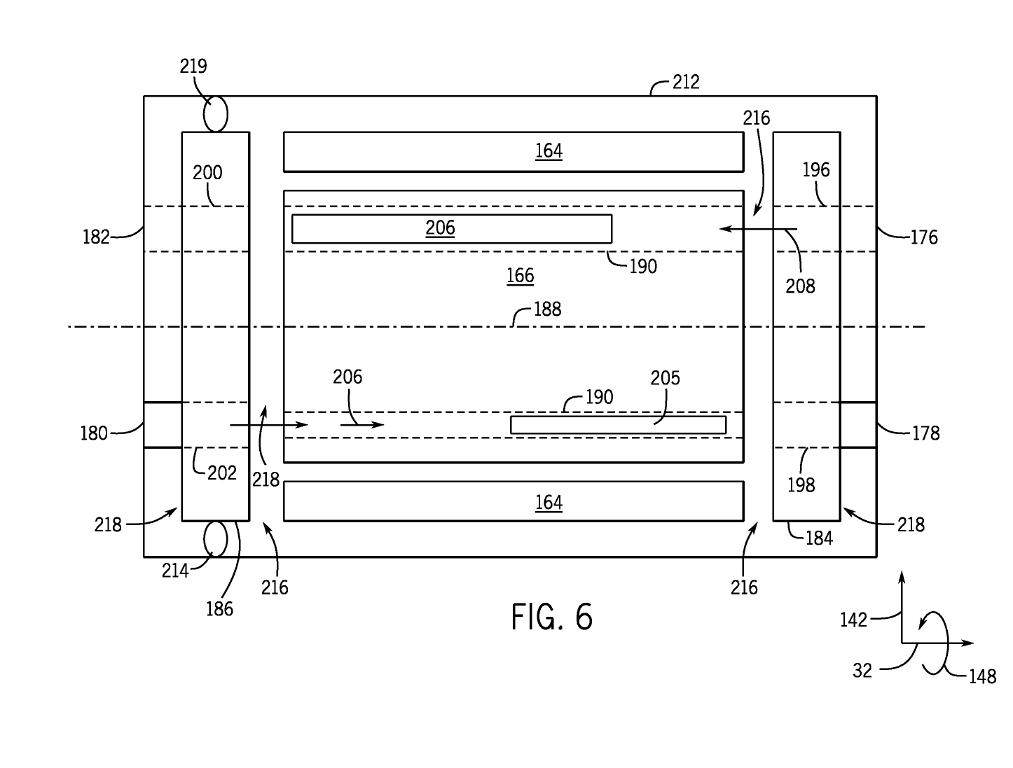

In FIG. 5, the channel 190 has rotated through approximately 270 degrees of arc from the position shown in FIG. 6. In this position, the outlet 194 is no longer in fluid communication with the apertures 200 and 202 of end cover 186, and the opening 192 is no longer in fluid communication with the apertures 196 and 198 of end cover 184. Accordingly, the first fluid 208 is no longer pressurized and is temporarily contained within the channel 190 until the rotor 166 rotates another 90 degrees, starting the cycle over again.

FIG. 6 is a schematic cross-sectional view of an embodiment of the rotary IPX 160. It will be appreciated that FIG. 6 is a simplified view of the rotatory IPX 160 and certain details have been omitted for clarity. In the illustrated embodiment, the rotary IPX 160 includes the housing 212 (e.g., annular housing) containing the sleeve 164 (e.g., annular sleeve), the rotor 166, the end covers 184, 186, and a seal 214 (e.g., annular seal) among other components. As illustrated, the seal 214 may be disposed between the housing 212 and the end covers 186 to direct the flow of the first fluid 208 through the rotor 166. However, in the illustrated embodiment, the seal 214 is not positioned about the end cover 184. As discussed above, the HP first fluid 208 may enter the rotary IPX 160 axially through the inlet 176 and the aperture 196 to drive the LP second fluid 206 out of the channel 190.

In FIG. 6, a first interface 216 (e.g., axial interface along a radial plane) is positioned axially between the aperture 196 and the rotor 166. At the first interface 216, the first fluid 208 enters the channel 190, thereby driving the second fluid 206 from the channel 190 and out of the rotor 166 via the aperture 200. Additionally, a second interface 218 (e.g., axial interface along a radial plane) is positioned axially between the aperture 202 and the rotor 166. At the second interface 218, the second fluid 206 enters the channel 190, thereby driving the first fluid 208 from the channel 190 and axially out of the rotor 166 via the aperture 198. In certain embodiments, as the rotor 166 rotates and fluidly couples the apertures 196, 198, 200, 202 to the channels 190, a point contact may form between the channel 190 and the apertures 196, 198, 200, 202. As used herein, a point contact refers to an interface formed between two flow paths having different geometries. As will be described below, the point contact forms a substantially reduced cross sectional flow area. In other words, the point contact temporarily increases the velocity of fluid flowing through the point contact.

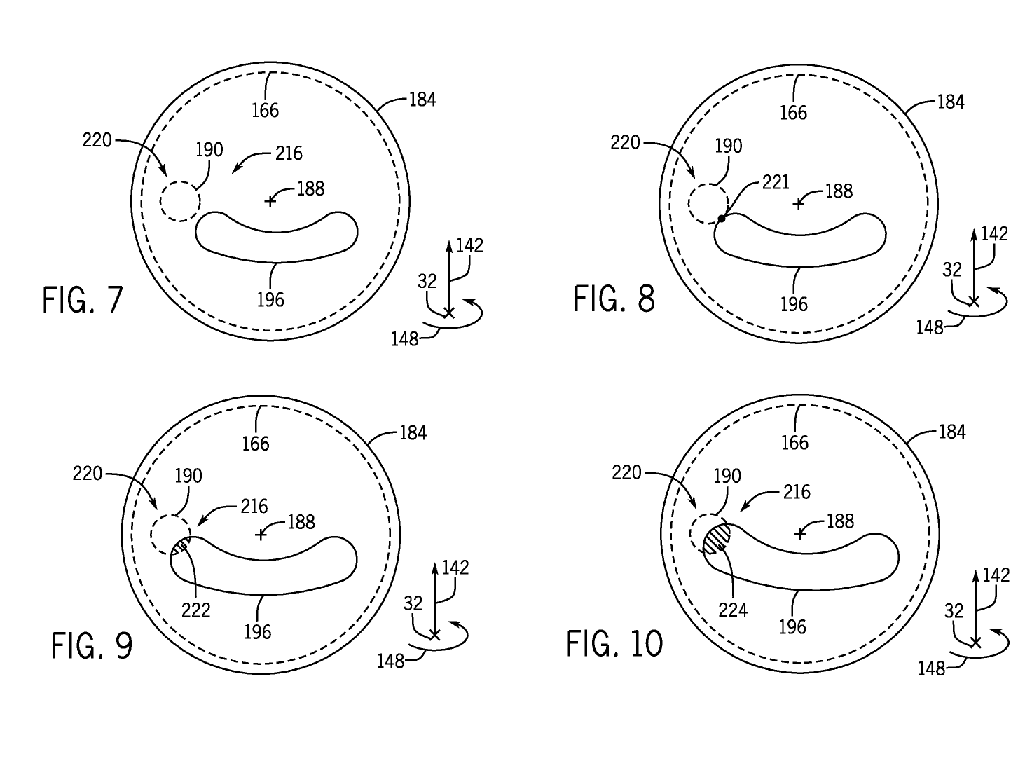

FIGS. 7-10 are schematic diagrams of embodiments of the first interface 216. In operation, the rotor 166 rotates in a direction 220 about the axis 188. As the rotor 166 rotates, the rotor 166 progressively aligns the channel 190 with the aperture 184, enabling the first fluid 208 to exit the aperture 196 and enter the channel 190. FIG. 7 illustrates the channel 190 moving toward the aperture 196 along the direction of rotation 220. As shown, the channel 190 does not overlap that aperture 196, thereby blocking fluid contact between the channel 190 and the aperture 196. FIG. 8 illustrates a point contact 221 between the channel 190 and the aperture 196. The point contact 221 is due in part to the oppositely curved shapes (e.g., perimeters of the channel 190 and the aperture 196). The point contact 221 represents a first location in which the channel 190 begins to overlap the aperture 196. Turning to FIG. 9, the channel 190 partially overlaps the aperture 196 and is exposed to the first fluid 208. In the illustrated embodiment, a first area 222 represents the portion of the channel 190 receiving the first fluid 208 as the channel 190 aligns with the aperture 196. As illustrated, the cross-sectional area of the first area 222 is smaller than the complete cross-sectional area of the channel 190 and the aperture 196, which increases the velocity of the first fluid 208 entering the channel 190. The increased velocity in the first area 222 may therefore increase wear on the rotor 166 and end cover (e.g., the end cover 184) around the first area 222. FIG. 10 illustrates the channel 190 substantially aligned with the channel 196. As shown, a second area 224 is in fluid contact with the aperture 196. In the illustrated embodiment, the second area 224 is larger than the first area 222, therefore the velocity in the second area 224 is less than the velocity in the first area 222. As a result, the likelihood of erosion is reduced as the channel 190 moves towards complete alignment with the aperture 196.

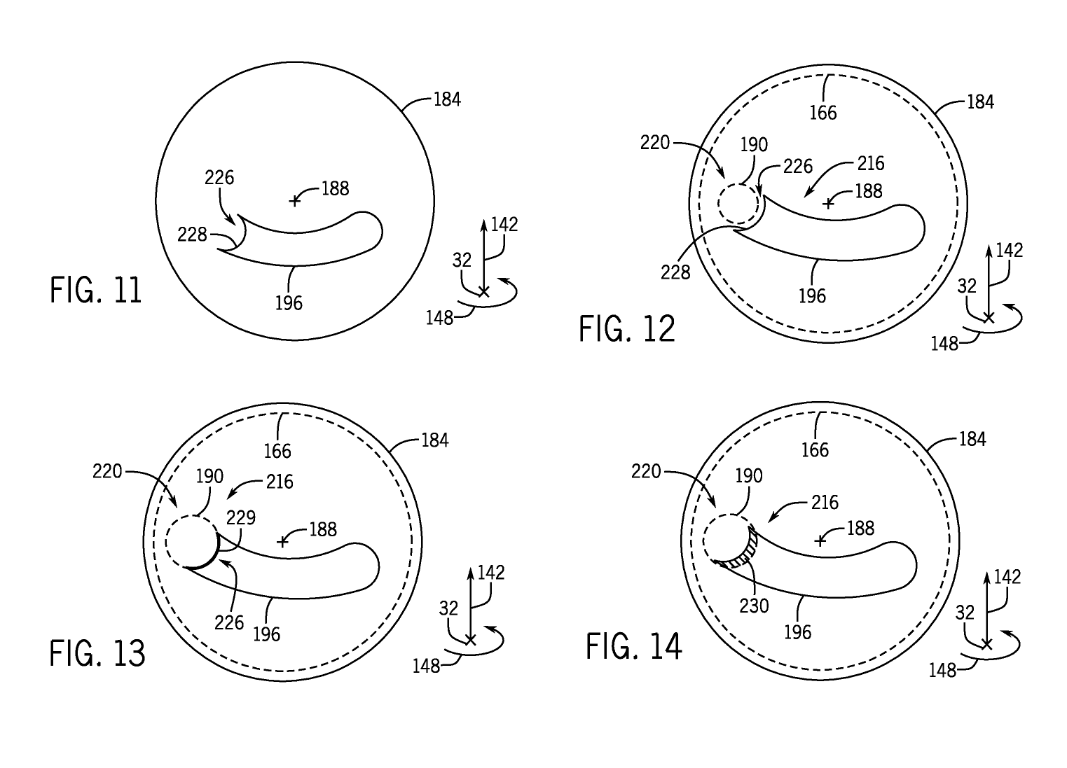

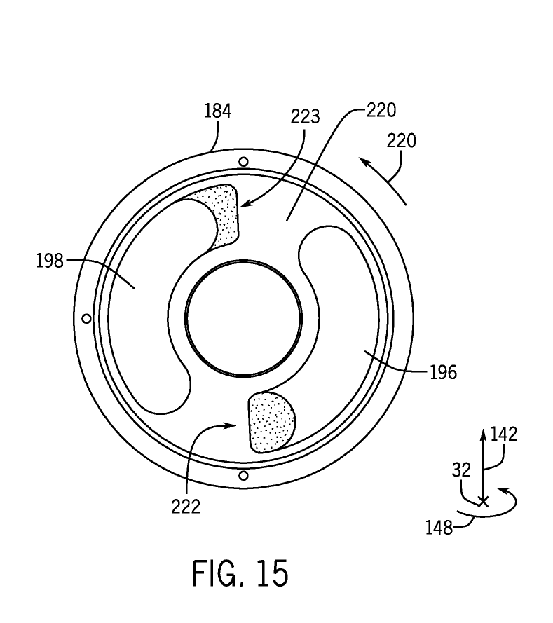

FIG. 11 is a schematic diagram of an embodiment of the aperture 196 having a modified geometry (e.g., a machined geometry, a cast geometry, an integrally formed geometry), which may be contoured to match or substantially match the contours of the channel 190. In the illustrated embodiment, a leading edge 226 of the aperture 196 may be machined to form a concave surface 228. The concave surface 228 is configured to substantially conform to the curvature of the channels 190. For example, in the illustrated embodiment, the channels 190 are generally circular, so the concave surface 228 may be generally circular to correspond to the channel 190. In other embodiments, the leading edge 226 may conform to other shapes of the channel 190 (e.g., arcuate, elliptical, trapezoidal, etc.) As will be described below, forming the leading edge 226 of the aperture 196 to conform to the shape of the channels 190 may reduce the likelihood of erosion by forming a line contact (e.g., a curved line contact) between the aperture 196 and the channel 190. Moreover, in certain embodiments, the aperture 196 may include a spotface feature (e.g., a circumferentially extending depression or indentation) that may conform to the shape of the channels 190 as discussed further with respect to FIG. 15. As used herein, a line contact refers to an elongated contact interface formed between two flow paths. As will be described below, the line contact facilitates the formation of a larger cross sectional flow area faster than a point contact.

FIGS. 12-14 are schematic diagrams of embodiments of the first interface 216. FIG. 12 illustrates the channel 190 moving in the direction of rotation 220 toward the leading edge 226 of the aperture 196. As described above, rotation of the rotor 166 brings the channel 190 into fluid contact with the aperture 196, thereby enabling the transfer of energy between the first and second fluids 208, 206. FIG. 13 illustrates a line contact 229 (e.g., curved line contact) between the channel 190 and the aperture 196. As shown, the geometry of the channel 190 substantially aligns with the geometry of the leading edge 226 of the aperture 196. As a result, the first location in which the channel 190 overlaps the aperture 196 extends across an arc length of the channel 190. As will be appreciated, extending the interface over the line contact 229 forms a larger cross-sectional flow area faster than forming the interface at the point contact 221. Turning to FIG. 14, as the channel 190 rotates in the direction 220, the channel 190 overlaps with the aperture 200. As shown, a third area 230 engages the aperture 196 first, thereby enabling fluid flow into the channel 190. Additionally, in the illustrated embodiment, the third area 230 is larger than the first area 222, thereby decreasing the velocity of the first fluid 208 as the first fluid 208 enters the channel 190. As a result, the likelihood of erosion to the channel 190 may be reduced because of the increased cross-sectional area 230 formed by the line contact between the channel 190 and the aperture 196.

FIG. 15 is an axial view of an interior surface of the end cover 184 (e.g., the HP inlet end cover) having spotfaces 223 on the apertures 196, 198. The spotfaces 223 are circumferentially extending recessed features of the end cover 184, forming depressions on the interior surface of the end cover 184. In certain embodiments, the spotfaces 223 are graded features that extend circumferentially in a direction opposite the direction of rotation 220 of the rotor 166. The spotfaces 223 are configured to increase the surface area as the first fluid 208 is directed toward the channels 190 by enabling flow to the channel 190 before the channel 190 is fully aligned with the apertures 196, 198. Increasing the surface area decreases the velocity of the first fluid 208 and also increases the duration for first fluid 208 to enter the channel 190, thereby increasing the pressure drop of the first fluid 208.

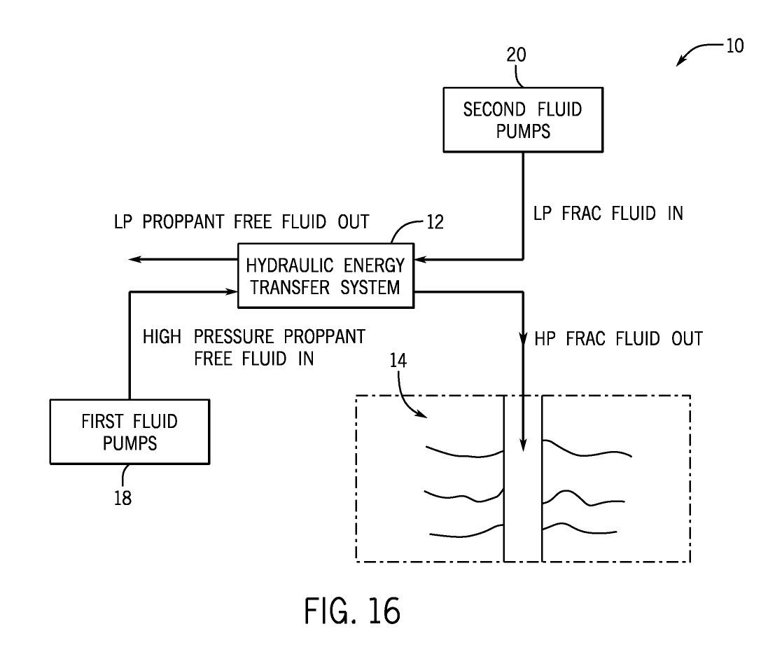

FIG. 16 is a schematic diagram of an embodiment of a frac system 10 (e.g., fluid handling system) with a hydraulic energy transfer system 12. In operation, the frac system 10 enables well completion operations to increase the release of oil and gas in rock formations. The frac system 10 may include one or more first fluid pumps 18 and one or more second fluid pumps 20 coupled to a hydraulic energy transfer system 12. For example, the hydraulic energy system 12 may include a hydraulic turbocharger, rotary IPX, reciprocating IPX, or any combination thereof. In addition, the hydraulic energy transfer system 12 may be disposed on a skid separate from the other components of a frac system 10, which may be desirable in situations in which the hydraulic energy transfer system 12 is added to an existing frac system 10. In operation, the hydraulic energy transfer system 12 transfers pressures without any substantial mixing between a first fluid (e.g., proppant free fluid) pumped by the first fluid pumps 18 and a second fluid (e.g., proppant containing fluid or frac fluid) pumped by the second fluid pumps 20. In this manner, the hydraulic energy transfer system 12 blocks or limits wear on the first fluid pumps 18 (e.g., high-pressure pumps), while enabling the frac system 10 to pump a high-pressure frac fluid into the well 14 to release oil and gas. In addition, because the hydraulic energy transfer system 12 is configured to be exposed to the first and second fluids, the hydraulic energy transfer system 12 may be made from materials resistant to corrosive and abrasive substances in either the first and second fluids. For example, the hydraulic energy transfer system 12 may be made out of ceramics (e.g., alumina, cermets, such as carbide, oxide, nitride, or boride hard phases) within a metal matrix (e.g., Co, Cr or Ni or any combination thereof) such as tungsten carbide in a matrix of CoCr, Ni, NiCr or Co.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. A rotary isobaric pressure exchanger (IPX) for transferring pressure energy from a high pressure fluid to a low pressure fluid, comprising:
a cylindrical rotor configured to rotate circumferentially about a rotational axis and having a first end face and a second end face disposed opposite each other with a plurality of channels extending axially therethrough between respective apertures located in the first and second end faces;
a first end cover having a first surface that interfaces with and slidingly and sealingly engages the first end face, wherein the first end cover has at least one first fluid inlet and at least one first fluid outlet that during rotation of the cylindrical rotor about the rotational axis alternately fluidly communicate with at least one channel of the plurality of channels, and wherein the at least one first fluid inlet has a first aperture at the first surface and the at least one first fluid outlet has a second aperture at the first surface; and
a second end cover having a second surface that interfaces with and slidingly and sealingly engages the second end face, wherein the second end cover has at least one second fluid inlet and at least one second fluid outlet that during rotation of the cylindrical rotor about the rotational axis alternately fluidly communicate with at least one channel of the plurality of channels, and wherein the at least one second fluid inlet has a third aperture at the second surface and the at least one second fluid outlet has a fourth aperture at the second surface; and
wherein a leading edge of at least one of the first aperture, the second aperture, the third aperture, and the fourth aperture comprises a contour that corresponds to a respective contour of a respective aperture of at least one channel of the plurality of channels.

2. The rotary IPX of claim 1, wherein the contour of the leading edge and the respective contour of the respective aperture form a line contact along an entire length of the contour of the leading edge upon initial fluid communication between either the first fluid inlet, the first fluid outlet, the second fluid inlet, or the second fluid outlet and the at least one channel of the plurality of channels.

3. The rotary IPX of claim 2, wherein the contour of the leading edge comprises a concave shape.

4. The rotary IPX of claim 3, wherein the contour of the leading edge and the respective contour of the at least one channel both comprises a curved shape.

5. The rotary IPX of claim 2, wherein the line contact extends in a radial direction relative to the rotational axis.

6. The rotary IPX of claim 1, wherein the leading edge of the first aperture comprises the contour that corresponds to the respective contour of the respective aperture of at least one channel on the first end face.

7. The rotary IPX of claim 6, wherein the first end cover comprises a spotface formed in the first surface adjacent to the leading edge.

8. The rotary IPX of claim 1, wherein the leading edge of the second aperture comprises the contour that corresponds to the respective contour of the respective aperture of at least one channel on the first end face.

9. The rotary IPX of claim 8, wherein the first end cover comprises a spotface formed in the first surface adjacent to the leading edge.

10. The rotary IPX of claim 1, wherein the leading edge of the third aperture comprises the contour that corresponds to the respective contour of the respective aperture of at least one channel on the second end face.

11. The rotary IPX of claim 10, wherein the second end cover comprises a spotface formed in the second surface adjacent to the leading edge.

12. The rotary IPX of claim 1, wherein the leading edge of the fourth aperture comprises the contour that corresponds to the respective contour of the respective aperture of at least one channel on the second end face.

13. The rotary IPX of claim 12, wherein the second end cover comprises a spotface formed in the second surface adjacent to the leading edge.

14. The rotary IPX of claim 1, wherein a respective leading edge of each of the first aperture, the second aperture, the third aperture, and the fourth aperture comprises the contour that corresponds to the respective contour of the respective aperture of at least one channel.

15. The rotary IPX of claim 1, comprising a frac system having the rotary IPX, wherein the low pressure second fluid comprises a frac fluid having proppants and the high pressure second fluid comprises a proppant free fluid.

16. A system, comprising:
a hydraulic transfer system configured to transfer pressure energy from a high pressure fluid to a low pressure fluid, comprising:
a rotary isobaric pressure exchanger (IPX) configured to exchange pressures between the high pressure fluid and the low pressure fluid, wherein the high pressure fluid has a pressure higher than the low pressure fluid;
a sleeve;
a cylindrical rotor configured to rotate circumferentially about a rotational axis and having a first end face and a second end face disposed opposite each other with a plurality of channels extending axially therethrough between respective apertures located in the first and second end faces;
a first end cover having a first surface that interfaces with and slidingly and sealingly engages the first end face, wherein the first end cover has at least one first fluid inlet and at least one first fluid outlet that during rotation of the cylindrical rotor about the rotational axis alternately fluidly communicate with at least one channel of the plurality of channels, and wherein the at least one first fluid inlet has a first aperture at the first surface and the at least one first fluid outlet has a second aperture at the first surface; and
a second end cover having a second surface that interfaces with and slidingly and sealingly engages the second end face, wherein the second end cover has at least one second fluid inlet and at least one second fluid outlet that during rotation of the cylindrical rotor about the rotational axis alternately fluidly communicate with at least one channel of the plurality of channels, and wherein the at least one second fluid inlet has a third aperture at the second surface and the at least one second fluid outlet has a fourth aperture at the second surface; and
wherein a leading edge of at least one of the first aperture, the second aperture, the third aperture, and the fourth aperture comprises a contour that corresponds to a respective contour of a respective aperture of at least one channel of the plurality of channels.

17. The system of claim 16, wherein the contour of the leading edge and the respective contour of the respective aperture form a line contact along an entire length of the contour of the leading edge upon initial fluid communication between either the first fluid inlet, the first fluid outlet, the second fluid inlet, or the second fluid outlet and the at least one channel of the plurality of channels

18. The system of claim 16, wherein the contour of the leading edge and the respective contour of the at least one channel both comprises a curved shape.

19. A method, comprising:
rotating a cylindrical rotor of a rotary isobaric pressure exchanger about a rotational axis, wherein the cylindrical rotor comprises a plurality of channels extending between a first end face and a second end face disposed opposite each other; and
forming a line contact between a contour of a leading edge of an aperture of a fluid inlet of a first end cover and a respective contour of a respective aperture of channels upon initial fluid communication between the fluid inlet and the at least one channel, wherein the first end cover interfaces with and slidingly engages the first end face along a first surface.

20. The method of claim 19, wherein the contour of the leading edge comprises a concave shape.
